(19) United States
(12) Patent Application Publication
(10) Pub. No.: US 2012/0242561 A1
(43) Pub. Date: Sep. 27, 2012

(54) Head-Mounted Display Device

(76) Inventor: Ryohei Sugihara, Tokyo (JP)

(21) Appl. No.: 13/424,767

(22) Filed: Mar. 20, 2012

(30) Foreign Application Priority Data
Mar. 24, 2011 (JP) 2011-066168

(51) Int. Cl. G09G 5/00

(52) U.S. Cl. 345/8

(57) ABSTRACT

A head-mounted display device includes: a light guide prism in a polyhedron shape having a first optical surface facing a wearer side in a mounted state, and a third and a fourth optical surfaces each forming an acute interior angle with the first optical surface; a video display portion for emitting video light toward an incident portion on the first optical surface; and an eyepiece lens cemented to or integrally formed with an emitting portion on the first optical surface. Video light incident on the incident portion on the first optical surface is reflected by the third optical surface, the first optical surface and the fourth optical surface, and is emitted toward a pupil direction of the wearer on an optical axis of the eyepiece lens. The incident portion and the reflecting portion overlap each other in part while the emitting portion avoids overlapping with the reflecting portion.

### CROSS-REFERENCE TO RELATED APPLICATION

The present application claims priority from Japanese Patent Application No. 2011-066168, filed on Mar. 24, 2011, the content of which is incorporated herein by reference.

### TECHNICAL FIELD

The present invention relates to a head-mounted display device.

### RELATED ART

There has been known a head-mounted display device in which a light guide prism for guiding video light emitted from an video display element and an eyepiece lens for observing, as a virtual image, a video image from the video display element are used in combination, so that the video image can be observed as an aerial image displayed in front of a visual field.

In particular, for a head-mounted display device which is also designed for outdoor use, it is important to reduce the device size. For example, there has been proposed a device in which a video display element and a light guide prism are separately held by different portions (such as a frame and a lens) of spectacles (see, for example, JP 2010-226661 A). In this case, it is essential to hold the video display element, the light guide prism, and an eyepiece lens in an appropriate relative position so as to allow the observer to observe a video image generated by the video display element in an appropriate position. Further, it is also necessary to make adjustments to the device in view of the individual differences in terms of head size of the wearer, such as head width, pupillary distance (interpupillary distance), and distance from the ear to the eyeball. For these purposes, according to JP 2010-226661 A, an adjustment mechanism is provided for adjusting the relative position between the light guide prism and the video display element.

Further, in the head-mounted display device using the light guide prism according to JP 2010-226661 A, video light exited from a video display element is made incident from one end of the light guide prism and reflected zigzag for odd number of times within the light guide prism, so as to be made incident on the eyepiece lens from the other end of the light guide prism through an air gap, so that the light can be emitted toward the eyeball. The video light is passed zigzag through the light guide prism, so as to reduce the light guide prism in thickness in a direction of the line of sight while ensuring a large width for the incident portion through which the video light is made incident on the light guide prism.

### DISCLOSURE OF THE INVENTION

When the light is reflected for odd number of times within the light guide prism as described in JP 2010-226661 A, there may be obtained a larger effect on pupil position adjustment due to the relative movement of the light guide prism and the video display element, as compared to the case where the light is reflected for even number of times. FIGS. 7A and 7B illustrate how the optical path changes in a head-mounted display device, which includes: a video display element 101; and a light guide prism 102 having an eyepiece lens 103 fixed to an emitting portion for emitting video light, when the video display element 101 and the light guide prism 102 are relatively displaced so as to adjust the pupil position. In FIG. 7A, video light is reflected for even number of times (twice) within the light guide prism 102, while in FIG. 7B, video light is reflected for odd number of times (five times). In the drawings, the solid lines and the dashed lines each render the configuration and the optical axis path before and after the movement, respectively, and the light guide prism 102 is moved substantially parallel to the video display element 101 which remains fixed. It is apparent from FIGS. 7A and 7B that an interpupillary distance adjustment width L₂ is small relative to the movement width L₁ of the light guide prism 102 when light is reflected twice within the light guide prism 102, whereas an interpupillary distance adjustment width L₃ is larger relative to the movement width L₁ of the light guide prism 102 when light is reflected five times within the light guide prism 102. In other words, when light is reflected for odd number of times within the light guide prism, a slight mechanical adjustment has great effect on interpupillary distance adjustment.

FIG. 8 is a diagram for illustrating optical paths of light passing through the optical system of FIG. 7B. As shown in FIG. 8, the light guide prism 102 has an incident portion 102a (a portion corresponding thereto on a surface of the light guide prism is indicated by a double-pointed arrow in the drawing) and an emitting portion 102c both formed as transparent reflecting surfaces for passing through vertical incident light while totally reflecting light guided within the prism. With this configuration, the transparent surface 102a and a reflecting surface 102b₁ form one continuous surface at the incident portion, so that the video display element 101 and the light guide prism 102 can be relatively displaced without rejecting the light rays by the effective regions thereof, to thereby allow light rays to pass therethrough. On the other hand, at the emitting portion 102c having the eyepiece lens 103 disposed thereon, a surface 102b₂ for performing total reflection in the light guide prism 102 and the transparent surface 102c for emitting video light to the eyepiece lens 103 overlap each other, which requires an air layer (air gap) to be formed between the light guide prism 102 and the eyepiece lens 103.

However, in the head-mounted display device configured as described above, due to the air gap thus formed, an external casing and/or a complicated holding mechanism become necessary in order to hold the eyepiece lens with respect to the light guide prism. It may be conceivable to adopt a configuration in which no air gap is formed and video light is reflected twice on the inclined surfaces on the incident side and on the exiting side within the light guide prism before exiting from the eyepiece lens. However, such a configuration cannot ensure a large interpupillary distance adjustment width.

A head-mounted display device according to the present invention includes: a light guide prism in a polyhedron shape having a first optical surface and a second optical surface opposed to each other, a third optical surface and a fourth optical surface opposed to each other, and a fifth optical surface and a sixth optical surface opposed to each other, the first optical surface facing a wearer side in a mounted state, the third optical surface and the fourth optical surface each forming an acute interior angle with the first optical surface, the fifth optical surface and the sixth optical surface each being in contact with the first optical surface, the second optical surface, the third optical surface, and the fourth optical surface, respectively;

a video display portion for emitting video light toward an incident portion on the first optical surface of the light guide prism; and

an eyepiece lens cemented to or integrally formed with an emitting portion on the first optical surface of the light guide prism,

in which: the light guide prism is configured so that the video light incident on the incident portion on the first optical surface is reflected by the third optical surface, reflected between the first optical surface and the second optical surface for odd number of times in total, and further reflected by the fourth optical surface, so as to be emitted, as passing through the eyepiece lens, toward a pupil direction of a wearer on an optical axis of the eyepiece lens; and

the incident portion and the reflecting portion on the first optical surface overlap each other in part while the emitting portion avoids overlapping with the reflecting portion.

Here, the term “opposed” refers to a state where surfaces are arranged as being facing each other, which includes either one of the cases where the two surfaces are parallel to each other and where the surfaces are arranged as being at an angle to each other.

It is preferred that the light guide prism be configured so that the video light reflected by the third optical surface is reflected once by the reflecting portion on the first optical surface and then reflected by the fourth optical surface, and that the video light have an optical axis reflected by the reflecting portion on the first optical surface at a position which is located on the incident portion side than the center between two sides of the first optical surface, the two sides each being in contact with the third optical surface and the fourth optical surface, respectively. It is further preferred that the second optical surface be formed as a light-absorbing surface.

Alternatively, the light guide prism may be cut out in portion where the video light exiting toward the pupil direction of the wearer does not pass through, the portion including the second optical surface, and the portion thus cut out may leave a section having a surface formed as a light-absorbing surface.

Further, it is preferred that the eyepiece lens be disposed at a position capable of functioning as an aperture stop for limiting light beams of the video light exiting from the video display portion to be emitted toward the pupil direction of the wearer.

Further, the first optical surface of the light guide prism may be bent between the emitting portion and the reflecting portion so that a normal direction of an exiting surface, through which the video light exits from the emitting portion is directed toward a pupil of the wearer.

Still further, the head-mounted display device may preferably be provided with a slide mechanism for moving the light guide prism, relative to the video display portion, in a direction across a direction in which the video light is emitted from the video display portion.

Further, it is preferred that the emitting portion on the first optical surface has a width in at least one direction reduced to smaller than 4 mm, which is an average pupil diameter of human.

### BRIEF DESCRIPTION OF THE DRAWINGS

FIG. 1 is a plan view schematically illustrating a head-mounted display device according to a first embodiment of the present invention, which is mounted on spectacles.

FIG. 2A is a top view schematically illustrating a configuration of an optical system of the head-mounted display device of FIG. 1, together with light beams.

FIG. 2B is a front view of the light guide prism of the head-mounted display device of FIG. 1

FIG. 3A is a front view illustrating a slide mechanism of the head-mounted display device of FIG. 1.

FIG. 3B is a top view illustrating a slide mechanism of the head-mounted display device of FIG. 1.

FIG. 4A is a diagram for illustrating changes of optical paths that occur when the video display element and the light guide prism are shifted in relative position.

FIG. 4B is a diagram for illustrating changes of optical paths that occur when the video display element and the light guide prism are shifted in relative position.

FIG. 5 is a diagram schematically illustrating a configuration of an optical system of a head-mounted display device according to a second embodiment of the present invention, and light beams guided therethrough.

FIG. 6 is a diagram schematically illustrating a configuration of an optical system of a head-mounted display device according to a third embodiment of the present invention.

FIG. 7A is a diagram for illustrating pupil position adjustment made by relative movement of the video display element and the light guide prism.

FIG. 7B is a diagram for illustrating pupil position adjustment made by relative movement of the video display element and the light guide prism.

FIG. 8 is a diagram for illustrating optical paths of light passing through an optical system of FIG. 7B.

### BEST MODES FOR CARRYING OUT THE INVENTION

In the following, embodiments of the present invention are described with reference to the drawings.

### First Embodiment

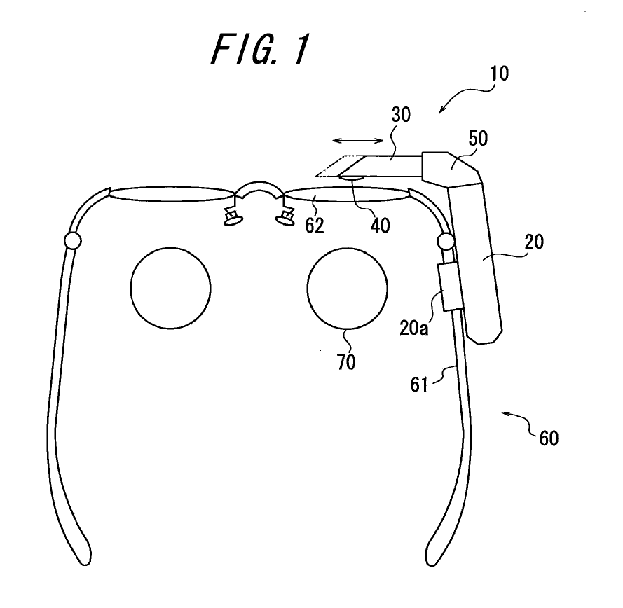

FIG. 1 is a plan view schematically illustrating a head-mounted display device 10 according to a first embodiment of the present invention, which is mounted on spectacles 60. The head-mounted display device 10 includes an eyepiece optical portion which is mainly formed of a main body portion 20, a light guide prism 30, and an eyepiece lens 40. When mounting the head-mounted display device 10 onto the spectacles 60, the main body portion 20 is attached, by means of a support portion 20a or the like, to a temple on the right side of a frame 61 of the spectacles 60 worn on the head of a wearer.

The main body portion 20 extends along the frame 61 of the spectacles 60 to the front of the wearer, and a leading end thereof is coupled to the light guide prism 30 via an attachment portion 50 to be described later, on the side of a right spectacle lens 62. The light guide prism 30 extends, in front of the right spectacle lens 62 of the spectacles 60, substantially horizontally from the attachment portion 50 to the inside of the visual field of the wearer. As described later, the light guide prism 30 guides video light emitted from the main body portion 20, and emits the light from the eyepiece lens 40 fixed to the leading end thereof toward an eyeball 70.

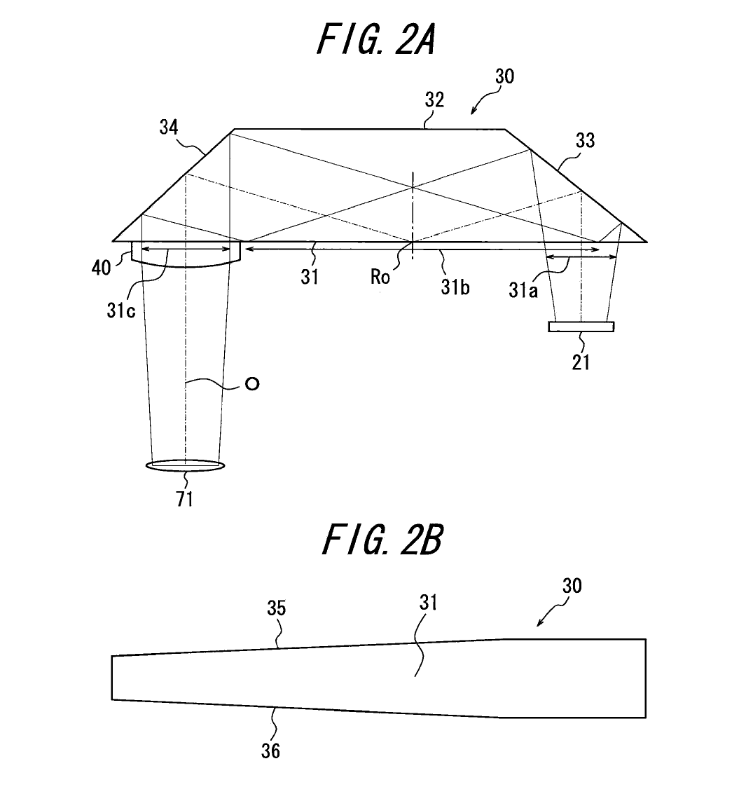

FIG. 2A is a diagram schematically illustrating a configuration of the optical system of the head-mounted display device of FIG. 1, together with light beams. FIG. 2A is a top view from the head side of the wearer in FIG. 1. FIG. 2B is a front view of the light guide prism from a side opposed to the wearer in FIG. 1. This optical system is configured by including a video display element 21 serving as a video display portion, the light guide prism 30, and the eyepiece lens 40.

The video display element 21 is an element such as a liquid crystal display element or an organic EL element for displaying an image to be observed. The video display element 21 is mounted inside a casing of the main body portion 20. Video light from a video image displayed on the video display element 21 is caused to incident on the light guide prism 30. It is preferred to provide a protection window for protecting the video display element 21, in the vicinity of the element surface of the video display element 21.

The light guide prism 30 is a prism formed of plastic or glass, and slidably supported by the attachment portion 50 of FIG. 1 fixed to the main body portion 20. An end portion of the light guide prism 30 that slides relative to the attachment portion 50 may be stored in a casing covering the outer circumference.

The light guide prism 30 is a hexahedron prism having a first optical surface 31, a second optical surface 32, a third optical surface 33, a fourth optical surface 34, a fifth optical surface 35, and a sixth optical surface 36. The first optical surface 31 and the second optical surface 32 are surfaces opposed to each other in the hexahedron, which are substantially parallel to each other. The third optical surface 33 and the fourth optical surface 34 are surfaces opposed to each other in the hexahedron, which are inclined in a direction facing each other, relative to the first optical surface 31. That is, the third optical surface 33 and the fourth optical surface 34 each form an acute interior angle with the first optical surface 31. Further, the third optical surface 33 and the fourth optical surface 34 each have a mirror coating formed thereon.

Specifically, as illustrated in FIGS. 2A and 2B, the light guide prism 30 has a substantially trapezoidal section which is formed by the first optical surface 31, the second optical surface 32, the third optical surface 33, and the fourth optical surface 34. Further, in this trapezoidal section, the first optical surface 31 is longer than the second optical surface 32, and the second optical surface 32 is longer than the third optical surface 33 and than the fourth optical surface 34.

On the other hand, the fifth optical surface 35 and the sixth optical surface 36 are surfaces opposed to each other in the hexahedron, which are in contact with the first to fourth optical surfaces 31 to 34, respectively. The fifth optical surface 35 and the sixth optical surface 36 are gradually inclined in a direction facing each other. As is appreciated from FIG. 2B, the fifth optical surface 35 and the sixth optical surface 36 are inclined in such a manner that the spacing therebetween narrows from the third optical surface 33 to the fourth optical surface 34, so that the spacing on the fourth optical surface 34 side is reduced to smaller than 4 mm, which is an average pupil diameter of human. The fifth optical surface 35 and the sixth optical surface 36 do not serve as optical surfaces that are necessary for allowing the wearer to observe a video image, and may preferably be formed as light-absorbing surfaces in order to prevent the generation of unnecessary light.

The first optical surface 31 is positioned so as to face the wearer in a state where the head-mounted display device 10 is worn by the wearer. The video display element 21 is disposed so as to emit video light toward an incident portion 31a of the first optical surface 31 on the third optical surface 33 side. Further, the first optical surface 31 has an emitting portion 31c on the fourth optical surface 34 side, the emitting portion 31c having the eyepiece lens 40 cemented thereto or integrally formed therewith. Here, the emitting portion 31c positioned between the fifth optical surface 35 and the sixth optical surface 36 has a width smaller than 4 mm in the vertical direction.

FIG. 2A also shows light beams of video light which is exited from the video display element 21 to be guided through the light guide prism 30 and emitted from the eyepiece lens 40 in a pupil direction of the wearer on the optical axis of the eyepiece lens 40. In this optical system, the eyepiece lens 40 is disposed at a position capable of functioning as an aperture stop for limiting light beams of video light. Video light exited from the video display element 21 is made incident on the incident portion 31a (a portion corresponding thereto on a surface of the light guide prism is indicated by a double-pointed arrow in the drawing, hereinafter the same in the rest of the drawings) on the first optical surface 31 of the light guide prism 30 and passes therethrough. Thereafter, the video light is reflected by the third optical surface 33 as a mirror surface, and incident on a reflecting portion 31b on the first optical surface 31 at an angle larger than a critical angle so as to be reflected. The video light reflected by the reflecting portion 31b on the first optical surface 31 is further reflected by the fourth optical surface 34 as a mirror surface, and passes through an emitting portion 31c on the first optical surface 31 so as to be incident on the eyepiece lens 40. The video light incident on the eyepiece lens 40 is emitted toward a pupil 71 of the wearer due to the positive power of the eyepiece lens 40. As a result, a video image is displayed as an aerial image in the visual field of the wearer.

In the light guide prism 30, the first optical surface 31 and the third optical surface 33 form an interior angle smaller than an interior angle formed by the first optical surface 31 and the fourth optical surface 34. With this configuration, video light has an optical axis 0 reflected by the reflecting portion 31b on the first optical surface 31 at a position R_{O}, which is located on the incident portion side (on the third optical surface 33 side) than the center (the center of the base of the trapezoidal section of the light guide prism 30 in the drawing) between two sides of the first optical surface 31, the sides each being in contact with both the third optical surface 33 and the fourth optical surface 34, respectively. As a result, light beams of video light that are made incident from the incident portion 31a on the first optical surface 31 and reflected by the third optical surface 33 are reflected in part by the same region as the incident portion 31a on the first optical surface 31. Further, the light beams of the video light is reflected by the reflecting portion 31b on the first optical surface 31, the reflecting portion being different from the emitting portion 31c on the first optical surface 31. In other words, the incident portion 31a and the reflecting portion 31b on the first optical surface 31 overlap each other in part, whereas the reflecting portion 31b and the emitting portion 31c are separate from each other without overlapping each other. The reflecting portion 31b and the emitting portion 31c do not overlap each other, thereby eliminating the need to provide an air gap between the light guide prism 30 and the eyepiece lens 40.

Further, it is apparent from FIG. 2A that the second optical surface 32 does not serve as a reflection surface for video light. Therefore, the second optical surface 32 is formed as a light-absorbing surface for absorbing noise light such as stray light. Specifically, the second optical surface 32 is formed of, for example, a sandblasted surface that is painted black.

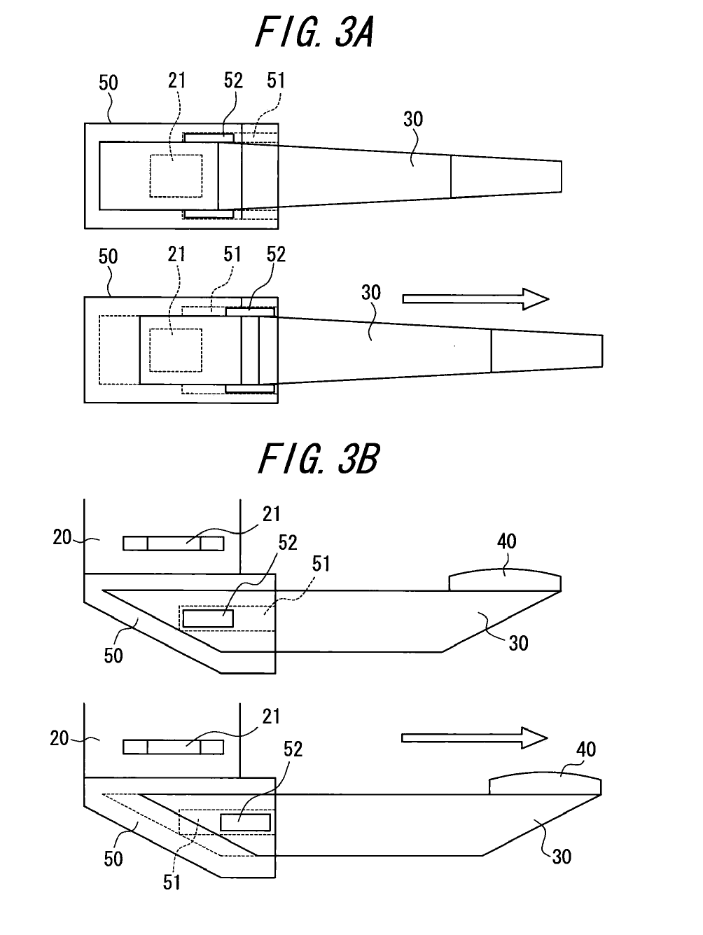

Next, description is given of a slide mechanism for moving the light guide prism 30 relative to the video display element 21 of the main body portion 20. FIGS. 3A and 3B are schematic diagrams each illustrating a slide mechanism of the attachment portion 50 of FIG. 1. FIG. 3A is a front view from a side facing the wearer in FIG. 1, and FIG. 3B is a top view from the head side of the wearer in FIG. 1, each illustrating the mechanism before and after the movement, respectively. As shown in FIGS. 3A and 3B, the light guide prism 30 is slidably fit into, on the incident side for receiving video light (on the third optical surface 33 side), the attachment portion 50. The movement mechanism may include a grooved slide guide 51 provided to the attachment portion 50, and a raised slide guide 52 formed on a surface that does not function as an optical surface of the light guide prism 30 (or the casing thereof), so that the raised slide guide 52 is moved as being engaged in the grooved slide guide 51. At this time, the video display element 21 does not move. Accordingly, the slide mechanism moves, relative to the video display element 21, the light guide prism 30 in a direction across a direction in which video light is emitted from the video display element 21. The slide mechanism thus provided makes it easy to adjust the pupil position.

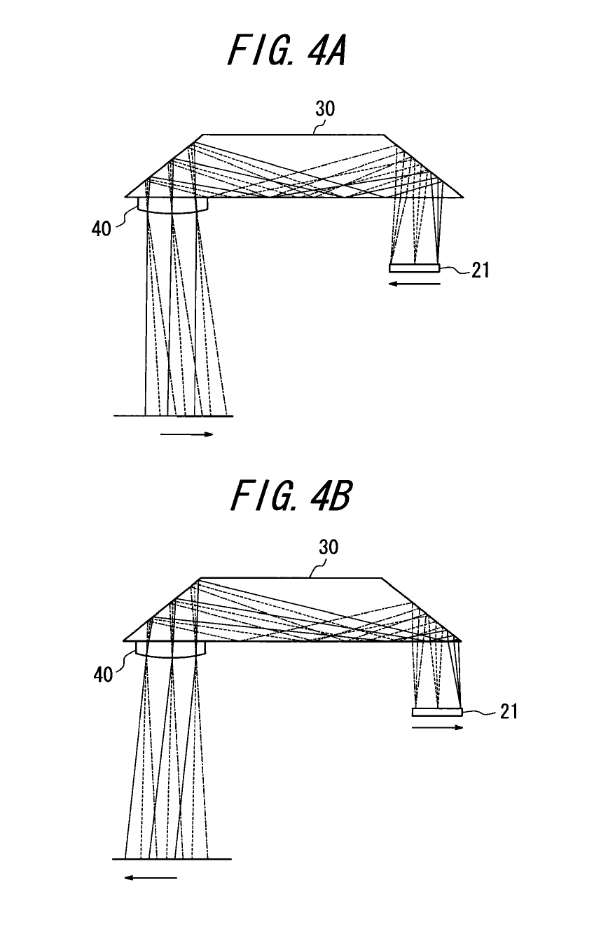

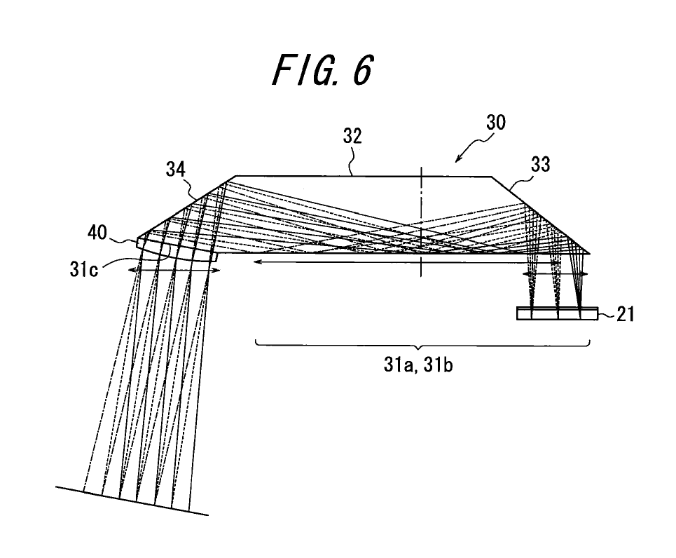

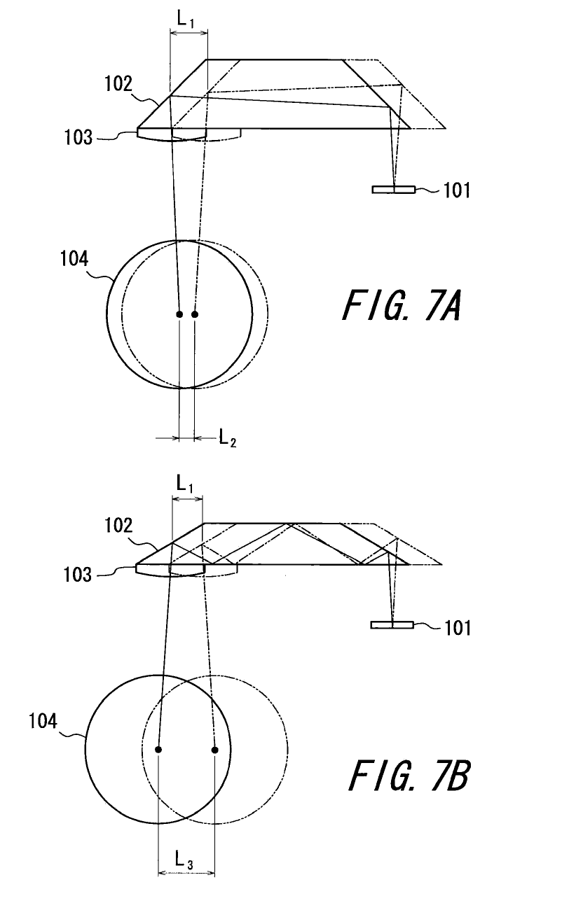

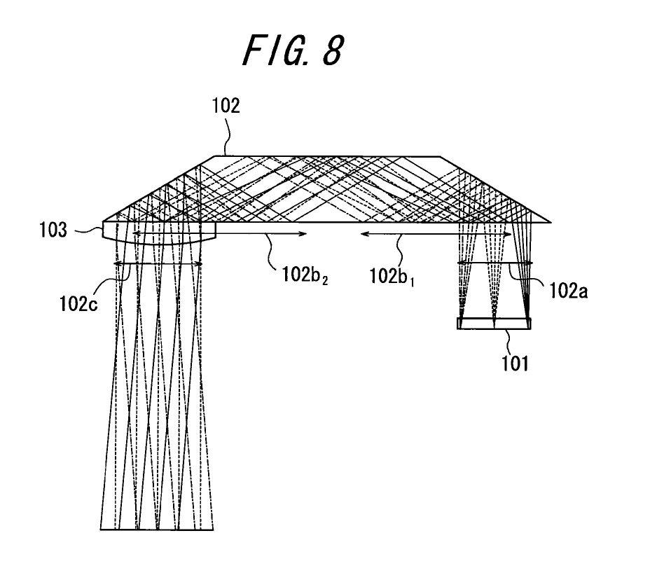

FIGS. 4A and 4B are diagrams each for illustrating optical paths when the video display element 21 and the light guide prism 30 are shifted in relative position. FIG. 4A illustrates a case where the light guide prism 30 is shifted in a direction of reducing the distance between the video display element 21 and the eyepiece lens 40 (in a direction of increasing the interpupillary distance), and FIG. 4B illustrates a case where the light guide prism 30 is shifted in a direction of increasing the distance between the video display element 21 and the eyepiece lens 40 (in a direction of reducing the interpupillary distance). In FIGS. 4A and 4B, light rays exiting from different three points in the video display element 21 are each rendered by a solid line, a broken line, and a dashed-dotted line, respectively (the same applies to FIGS. 6 and 8 to be described later). When the video display element 21 is relatively shifted to the left, the pupil position shifts to the right. When the video display element 21 is relatively shifted to the right, the pupil position shifts to the left. Accordingly, a slight adjustment width has greater effect on pupil position adjustment.

Here, the incident portion 31a on the video display element 21 side and the reflecting portion 31b inside the light guide prism 30 may be allowed to overlap each other. With this configuration, video light can still be allowed to be incident on the light guide prism 30 even when the display element 21 and the light guide prism 30 are relatively shifted by a large amount. Further, the emitting portion 31c through which video light exit from the light guide prism 30 and the reflecting portion 31b for reflecting the video light inside the light guide prism 30 always avoid overlapping each other as long as the light guide prism 30 is shifted within the above-mentioned range.

As described above, the present invention is configured in such a manner that the incident portion 31a and the reflecting portion 31b on the first optical surface 31 overlap each other in part thereof, which can provide a large adjustment width for adjusting the relative position between the video display element 21 and the light guide prism 30. Further, the emitting portion 31c is prevented from overlapping with the reflecting portion 31b while the emitting portion 31c on the first optical surface 31 has the eyepiece lens 40 cemented thereto or integrally formed therewith, which eliminates the need to provide an external casing or a complicated mechanism to hold the eyepiece lens 40 with respect to the light guide prism 30, to thereby simplify the holding mechanism therefor.

Further, since there is eliminated the need to provide an outer covering or a casing for holding the light guide prism 30, an eyepiece optical system can be easily reduced in diameter. With the eyepiece optical system reduced to smaller than 4 mm, which is an average pupil diameter of human, an electric video image can be observed as a see-through image superimposed on the external world.

Further, the second optical surface 32 is formed as a light-absorbing surface, which prevents degradation in visibility resulting from incident external light while absorbing ghost light resulting from undesired reflection inside the light guide prism 30, to thereby provide a display image that is easy to see.

Further, the eyepiece lens 40 is disposed at a position capable of functioning as an aperture stop for limiting light beams of video light, which makes it easy to design an optical system in which the reflecting portion 31b and the emitting portion 31c on the first optical surface 31 are properly separated from each other. In other words, the emitting portion 31c can be narrowed down to an appropriate aperture size so as to separate the reflecting portion 31b and the emitting portion 31c on the first optical surface 31 away from each other. Further, the eyepiece lens 40 is disposed at a position capable of functioning as an aperture stop for limiting light beams of video light, which allows the aperture size to be narrowed down without rejecting a video image.

In this embodiment, the emitting portion 31c on the first optical surface 31 has a width in at least one direction reduced to smaller than 4 mm, which is an average pupil diameter of human. However, a larger eyepiece lens can also be employed because of the unnecessity of an outer covering or a casing. In such a case, a video image can be observed with more ease.

Further, in this embodiment, the light guide prism 30 is configured so as to provide three times of reflection within the light guide prism 30, that is, the video light reflected by the third optical surface 33 is reflected once by the reflecting portion 31b on the first optical surface 31 before being reflected once by the fourth optical surface 34. However, the number of reflection may be other odd numbers of five or more as long as the incident portion 31a and the reflecting portion 31b on the first optical surface 31 overlap each other in part whereas the emitting portion 31c does not overlap with the reflecting portion 31b. Even in such a case, there may be obtained effects of providing a large adjustment width for adjusting the relative position between the video display element 21 and the light guide prism 30 while simplifying a holding mechanism for holding the eyepiece lens 40 with respect to the light guide prism 30. In particular, as in this embodiment, when the total number of reflection is three (once each by the third optical surface 33, the first optical surface 31, and the fourth optical surface 34), light beams passing through the eyepiece lens can be increased in diameter, to thereby display a larger image. Further, the light guide prism can be designed to be relatively short in length.

### Second Embodiment

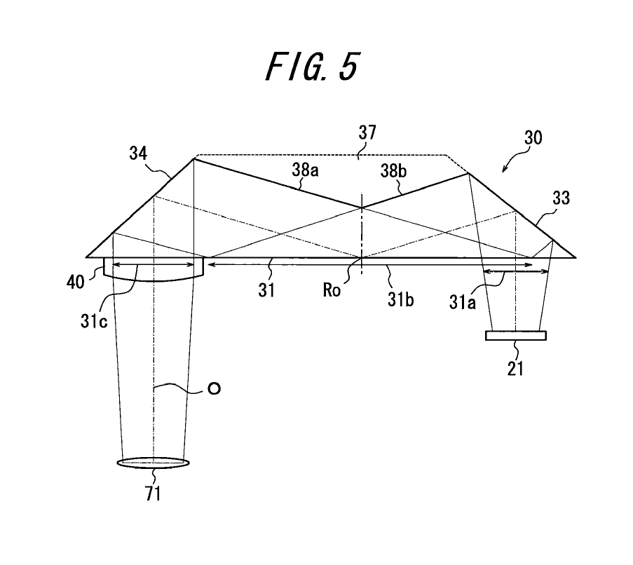

FIG. 5 is a diagram schematically illustrating a configuration of an optical system of a head-mounted display device according to a second embodiment of the present invention, which is a top view from the head side of the wearer. This embodiment is different from the first embodiment of FIG. 2 in that the light guide prism 30 is cut out in portion 37 where light beams do not pass through in any case where the light guide prism 30 and the video display element 21 are in either one of the relative positions. The second optical surface 32 of FIG. 2, which does not serve as a reflecting surface for video light, is cut out entirely. Further, the light guide prism 30 has surfaces 38a, 38b at a section left after the cutout, the surfaces being formed as light-absorbing surfaces, similarly to the second optical surface 32 of FIG. 1. Other configurations and operations are similar to those of the first embodiment, and thus the description thereof is omitted with the same constituent elements being denoted by the same reference symbols.

As described above, according to this embodiment, in addition to the effects obtained by the head-mounted display device 10 according to the first embodiment, there can be obtained a greater effect of removing ghost light because the light guide prism 30 is largely cut out in portion on the second optical surface 32 side and light-absorbing surfaces are formed on a section left after the cutout. Further, when the light guide prism 30 is largely cut out, the light guide prism 30 can be made compact and lightweight.

### Third Embodiment

FIG. 6 is a diagram schematically illustrating a configuration of an optical system of a head-mounted display device according to a third embodiment of the present invention, which is a top view from the head side of the wearer. The first optical surface 31 of the light guide prism 30 of FIG. 6 is bent between the emitting portion 31c and a portion including the incident portion 31a and the reflecting portion 31b, so that a normal direction of an exiting surface, through which the video light exits from the emitting portion is directed toward a pupil of the wearer. The exiting surface of the emitting portion 31c on the first optical surface 31 is tilted so as to be aligned along the lower edge of light beams of video light reflected by the reflecting portion 31b. In other words, the light guide prism 30 is formed in a shape without a region where light fluxes exiting from the emitting portion 31c on the first optical surface 31 pass through while light reflected by the reflecting portion 31b of the first optical surface 31 does not pass through, in the vicinity of the emitting portion 31c. It is preferred that the emitting portion 31c on the first optical surface 31 is tilted at 5 to 15 degrees relative to the incident portion 31a and to the reflecting portion 31b. When the angle of tilt is defined to fall within this range, the emitting portion 31c is tilted at an angle closer to the light beam angle of light reflected within the light guide prism 30. Other configurations and operations are similar to those of the first embodiment, and thus the description thereof is omitted with the same constituent elements being denoted by the same reference symbols.

As described above, according to this embodiment, in addition to the effects obtained by the head-mounted display device 10 according to the first embodiment, the light guide prism 30 can be made further compact because the emitting portion 31c on the first optical surface 31 side of the light guide prism 30 is tilted relative to the incident portion 31a and the reflecting portion 31b. Further, video light is made incident obliquely on an eyeball of the wearer, which is particularly preferred when displaying a video image near the edge of the visual field.

It should be noted that the present invention is not limited only to the above-mentioned embodiments, and may be subjected to various modifications and alterations. For example, the head-mounted display device is not limited to the one for right eye, and the device of the embodiments may be reversed left and right in design so as to be configured as a device for left eye. Further, the head-mounted display device is not limited to the one to be mounted on spectacles. For example, the device may be fixed to something like a helmet. Still further, in each embodiment described above, an attachment portion is provided between the main body part and the light guide prism, and a slide mechanism is provided so as to slide the attachment portion and the light guide prism in a relative manner. However, a method of adjusting the relative position between the light guide prism and the video display element is not limited thereto. For example, as described in JP 2010-226661 A, the light guide prism may be fixed to a lens of spectacles while adjusting the relative position of the display element. Further, the optical axis of video light from video display element does not need to be vertically incident on the incident portion on the first optical surface, and may be tilted within a range capable of attaining the effects of the present invention. Moreover, the light guide prism is not limited to a hexahedron prism, and may be configured as a polyhedron prism having at least six surfaces. Further, the term “polyhedron prism” also refers to a shape having rounded ridges between surfaces adjacent to each other.

### DESCRIPTION OF SYMBOLS

10 head-mounted display device
20 main body portion
20a support portion
21 video display element
30 light guide prism
31 first optical surface
31a incident portion
31b reflecting portion
31c emitting portion
32 second optical surface
33 third optical surface
34 fourth optical surface
35 fifth optical surface
36 sixth optical surface
37 cut-out portion
38a, 38b cut-out surface
40 eyepiece lens
50 attachment portion
51 slide guide (grooved)
52 slide guide (raised)
60 spectacles
70 eyeball
71 pupil
O optical axis
R_{O} optical axis reflecting position

1. A head-mounted display device, comprising:
a light guide prism in a polyhedron shape having a first optical surface and a second optical surface opposed to each other, a third optical surface and a fourth optical surface opposed to each other, and a fifth optical surface and a sixth optical surface opposed to each other, the first optical surface facing a wearer side in a mounted state, the third optical surface and the fourth optical surface each forming an acute interior angle with the first optical surface, the fifth optical surface and the sixth optical surface each being in contact with the first optical surface, the second optical surface, the third optical surface, and the fourth optical surface, respectively;
a video display portion for emitting video light toward an incident portion on the first optical surface of the light guide prism; and
an eyepiece lens cemented to or integrally formed with an emitting portion on the first optical surface of the light guide prism,
wherein the light guide prism is configured so that the video light incident on the incident portion on the first optical surface is reflected by the third optical surface, reflected between the first optical surface and the second optical surface for odd number of times in total, and further reflected by the fourth optical surface, so as to be emitted, as passing through the eyepiece lens, toward a pupil direction of a wearer on an optical axis of the eyepiece lens; and
wherein the incident portion and the reflecting portion on the first optical surface overlap each other in part while the emitting portion avoids overlapping with the reflecting portion.

2. The head-mounted display device according to claim 1, wherein the light guide prism is configured so that the video light reflected by the third optical surface is reflected once by the reflecting portion on the first optical surface and then reflected by the fourth optical surface.

3. The head-mounted display device according to claim 2, wherein the video light has an optical axis reflected by the reflecting portion on the first optical surface at a position which is located on the incident portion side than the center between two sides of the first optical surface, the two sides each being in contact with the third optical surface and the fourth optical surface, respectively.

4. The head-mounted display device according to claim 2, wherein the second optical surface is a light-absorbing surface.

5. The head-mounted display device according to claim 2, wherein the light guide prism is cut out in portion where the video light exiting toward the pupil direction of the wearer does not pass through, the portion including the second optical surface, and the portion thus cut out leaves a section having a surface formed as a light-absorbing surface.

6. The head-mounted display device according to claim 1, wherein the eyepiece lens is disposed at a position capable of functioning as an aperture stop for limiting the video light exiting from the video display portion to be emitted toward the pupil direction of the wearer.

7. The head-mounted display device according to claim 1, wherein the first optical surface of the light guide prism is bent between the emitting portion and the reflecting portion so that a normal direction of an exiting surface, through which the video light exits from the emitting portion, is directed toward a pupil of the wearer.

8. The head-mounted display device according to claim 1, further comprising a slide mechanism for moving the light guide prism, relative to the video display portion, in a direction across a direction in which the video light is emitted from the video display portion.

9. The head-mounted display device according to any one of claim 1, wherein the emitting portion on the first optical surface has a width in at least one direction reduced to smaller than 4 mm, which is an average diameter of human.
